(19) United States
(12) Patent Application Publication
(10) Pub. No.: US 2011/0306330 A1
(43) Pub. Date: Dec. 15, 2011

(54) SYSTEM AND METHOD FOR ANONYMOUS RECEPTION OF TELEPHONE CALLS

(75) Inventors: Michael A. Sharp, Porter, TX (US); Christopher Coleman, Germantown, TN (US)

(73) Assignee: Patent Holding, LLC, Porter, TX (US)

(21) Appl. No.: 13/138,481

(22) PCT Filed: Feb. 24, 2010
(86) PCT No.: PCT/US10/25140

§ 371 Date: Aug. 24, 2011

Related U.S. Application Data
(60) Provisional application No. 61/154,787, filed on Feb. 24, 2009.

(51) Int. Cl. H04W 4/00; H04W 88/02

(52) U.S. Cl. 455/417; 455/566; 455/422.1; 455/567; 455/550.1

(57) ABSTRACT

A disclosed wireless phone includes a user interface having at least one button, a processor coupled to the user interface to detect a user's activation of the button, and software stored in a memory including: an acquisition process to obtain a secondary phone number in response to the user's activation of the button, and a display process to display the secondary phone number to the user. A described telecommunications server provides the secondary phone number to the wireless phone, and includes a forwarding process that forwards incoming phone calls directed to the secondary phone number to the wireless phone with modified caller-id information. A described method of enabling anonymous reception of phone calls includes automatically determining a programmed phone number of a wireless phone, and providing a button that causes the wireless phone to automatically obtain a secondary phone number.

### RELATED APPLICATIONS

The present application claims priority to Provisional U.S. Patent Application 61/154,787, entitled “System and Method for Anonymous Reception of Telephone Calls” filed Feb. 24, 2009.

### BACKGROUND

A telephone (phone) converts voice and other sound signals into transmitted electromagnetic signals, and converts received electromagnetic signals into sound. Wireless phones convert voice and other sound signals into transmitted radio waves, and convert received radio waves into sound. Cellular (cell) phones, a type of wireless phones, have become quite common.

A phone call is a connection over a telephone network between a calling party, initiating the phone call, and a called party receiving the phone call. The phone call may carry voice information or digital data (via modulator-demodulators, or modems). Many wireless or cell phones have built-in modems, and can transmit and receive both voice information and data.

To receive phone calls, a phone must have a unique phone number, typically assigned by a phone service provider. Once a phone number is assigned, it is often inconvenient to have the phone number changed, at least in part because a change of phone number typically requires notifying those one wishes to receive phone calls from of the new phone number. As a result, phone users are reluctant to change their phone numbers.

Unwanted telephone calls can be annoying and/or distracting. Common kinds of unwanted calls include telemarketing calls, prank calls, and obscene phone calls. To avoid unwanted phone calls, a person may be reluctant to give his or her phone number to strangers, or to list his or her phone number in an ad for an item for sale. It would thus be advantageous to have the ability to obtain a disposable phone number that can be released to others, and to receive phone calls directed to the disposable phone number.

### SUMMARY

The problems outlined above are at least in part addressed by a novel system and method for anonymously receiving telephone (phone) calls. A disclosed wireless phone includes a user interface having at least one button, a processor coupled to the user interface to detect a user's activation of the button, and internal software stored in memory. The software includes an acquisition process that configures the processor to obtain a secondary phone number for the wireless phone in response the user's activation of the button, and a display process that configures the processor to display the secondary phone number to the user.

The software may include a disposal process that configures the processor to disassociate a secondary phone numbers associated with the wireless phone based at least in part on the expiration of a given time period. The software may also include a disposal process that configures the processor to disassociate a secondary phone number associated with the wireless phone if the user activates a disposal button. The software may also include a detection process that configures the processor to determine the dialed number of incoming calls. The processor may determine the dialed number based at least in part on a dialed number indicator in a caller-id field.

The software may also include a ringtone process that plays a selected ringtone to announce an incoming call, where selection of the ringtone is based at least in part on the dialed number of the incoming call. The software may also include a query process that configures the processor to query the user upon completion of an incoming phone call whether the dialed number should be disassociated from the wireless phone. The query process may configure the processor to display a call history for a secondary phone number when providing the user an option to have the secondary phone number expire or be disassociated from the wireless phone.

A described method of enabling anonymous reception of phone calls includes automatically determining a programmed phone number of a wireless phone with an application that executes on the wireless phone. A first button is provided that causes the wireless phone to automatically obtain a secondary phone number for the wireless phone. The method may also include obtaining the secondary phone number in response to activation of the first button, and making the secondary phone number available to a potential caller.

The making the secondary phone number available may include displaying the secondary phone number on the wireless phone. Alternatively, or in addition, the making the secondary phone number available may include communicating the secondary phone number in an electronic message directed to the potential caller.

The method may also include, at the wireless phone, associating each incoming call with the primary or secondary phone number that was dialed to make that call. The method may also include providing a second button that causes the wireless phone to disassociate a secondary phone number from the wireless phone.

A disclosed telecommunications server includes at least one processor that receives an incoming phone call to one of multiple numbers currently associated with a receiving phone, and a memory containing software. The software includes a caller-id process that causes the processor to modify a caller-id associated with the incoming phone call to characterize a dialed number of the incoming phone call, or in some cases, to anonymize the caller, and a forwarding process that causes the processor to forward the incoming phone call to the receiving phone with the modified caller-id.

The telecommunications server may maintain a list of secondary phone numbers associated with the receiving phone, and may insert a value into the caller-id to indicate the index of the dialed number in the list. In an alternative system embodiment that anonymizes the caller, the telecommunications server maintains a list of caller-id numbers for incoming callers to a given secondary phone number. The telecommunications server then generates a new caller-id identifying the secondary phone number and an appended value to indicated the index of the incoming caller-id number. In either case, the value may be a two-digit number or an ASCII value of an alphabetic character that is appended to the phone number in the caller-id. The processor may form a checksum of the dialed number and insert the checksum into the caller-id.

A disclosed calling method includes detecting a phone call directed to a dialed number, where the dialed number is one of multiple secondary phone numbers associated with a primary phone number. The phone call is forwarded to the primary phone number with modified caller-id information, where the modified caller-id information includes an indication of the dialed number and an (optionally anonymized) identification of the caller. The calling method may also include announcing the phone call with a ringtone that is selected based at least in part on the dialed number. The calling method may also include tracking caller-id information for each of multiple secondary phone numbers, and displaying call history information for a given secondary phone number.

A described wireless phone includes a speaker, a processor that detects an incoming phone call having a caller identification field value that includes a dialed-number indicator, and a memory containing software. The software includes a ringtone selector process that configures the processor to select a ringtone based at least in part on the dialed-number indicator, and a player process that configures the processor to play the selected ringtone via the speaker to announce the incoming phone call.

The wireless phone may have a primary phone number and at least one secondary phone number. The software may also include an acquisition process that configures the processor to obtain a new secondary number. The software may also include a query process that configures the processor to query the user upon completion of an incoming phone call whether the dialed number should be disassociated from the wireless phone.

A disclosed wireless phone includes a user interface having at least one button, a processor coupled to the user interface to detect the user's activation of the button, and a memory containing software. The software includes a logging process that tracks incoming caller identification information for each of multiple phone numbers dialed to reach the wireless phone, and a query process that displays the tracked caller identification for a phone number when the user activates the button to disassociate that phone number from the wireless phone.

In at least some embodiments, the caller identification information tracked by the wireless phone includes a dialed number indicator. The dialed number indicator may be an index in a list of phone numbers associated with the wireless phone. In at least some alternative embodiments, the caller identification information tracked by the wireless phone identifies callers in a manner that renders them anonymous, e.g., as indexes to a caller list kept on a server. In either case, the index value may be a two-digit number or an ASCII value of an alphabetic character that is appended to the phone number in the caller-id. The processor may form a checksum of the dialed number and insert the checksum into the caller-id.

### BRIEF DESCRIPTION OF THE DRAWINGS

A better understanding of the various disclosed embodiments can be obtained when the detailed description is considered in conjunction with the following drawings, in which:

FIG. 1 is a diagram of an illustrative communication system including a wireless telephone (wireless phone), a communication network, and a telecommunications server;

FIG. 2 is a front view of the wireless phone of FIG. 1;

FIG. 3 is a diagram of one embodiment of the telecommunications server of FIG. 1;

FIG. 4 is a diagram of one embodiment of a memory of the telecommunications server 16 of FIG. 3, wherein the memory includes application software and a list;

FIG. 5 is a diagram of one embodiment of the list of FIG. 4;

FIG. 6 is an illustrative embodiment of the wireless phone of FIGS. 1 and 2;

FIG. 7 is an illustrative embodiment of a memory of the wireless phone of FIG. 6, wherein the memory includes a copy of the application software;

FIG. 8 is a diagram of one embodiment of the application software of FIGS. 4 and 7;

FIG. 9 is a front view of the wireless phone of FIGS. 1, 2, and 6, where a button is displayed on a touch-sensitive display screen of a user interface;

FIG. 10 is a flowchart of one embodiment of a method for enabling anonymous reception of phone calls; and

FIG. 11 is a flowchart of one embodiment of a method for placing a telephone call.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### Terminology

The term “button” includes physical keys, switches, sliders, contacts, touch-sensitive surfaces, and graphical representations of such items that can be activated by a user.

The term “wireless phone” includes satellite telephones (phones), cellular phones, radio phones, and other communication devices that enable telephone calls to be carried out without being physically connected to a wall jack or a remote receiver.

The term “speaker” includes all forms of audio transducers including whistles, bells, eccentric mass vibrators, piezoelectric drivers, induction coils, and vibratory surfaces coupled to any such drivers.

### DETAILED DESCRIPTION

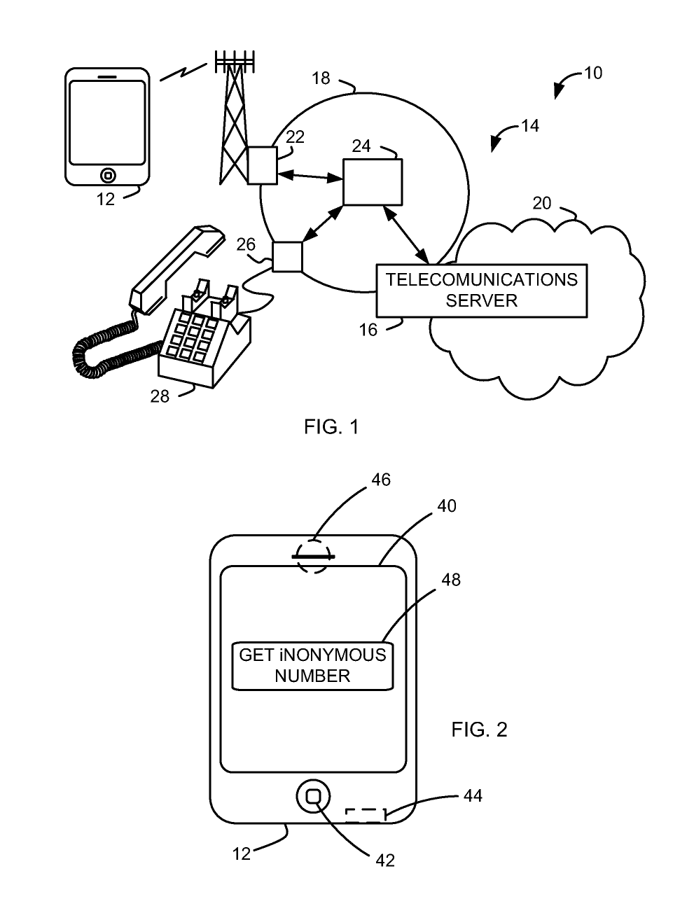

Turning now to the figures, FIG. 1 is a diagram of an illustrative communication system 10 including a wireless telephone 12 (wireless phone 12), a communication network 14, and a telecommunications server 16. The wireless phone 12 communicates with the telecommunications server 16 via the communication network 14. The communication network 14 includes a public switched telephone network (PSTN) 18 and the Internet 20. Although the PSTN 18 and the Internet 20 are shown as separate entities in FIG. 1, it will be understood that they may overlap, e.g., the Internet 20 may include portions of the PSTN 18 and vice versa.

The PSTN 18 includes a hierarchy of switches 22, 24, and 26, and communication links that interconnect customer provided equipment (CPE) such as cellular or wireless telephones (e.g., the wireless phone 12), “land-line” telephones such as the telephone labeled 28 (phone 28), and communication devices including modulator-demodulators (modems).

The telecommunications server 16 couples to the PSTN 18 for receiving and initiating phone calls, and for receiving and sending data. The telecommunications server 16 may, for example, connect to the PSTN 18 via a trunk line that supports multiple simultaneous phone calls. The telecommunications server 16 also couples to the Internet 20 for receiving and sending data. As described in more detail below, the telecommunications server 16 may include one or more processors executing telephony engine software such as, for example, the Asterisk® telephony engine software (Digium®, Inc., Huntsville, Ala.).

As described in more detail below, the wireless phone 12 has a phone number assigned by a phone system provider (e.g., a “primary” or programmed phone number). For various reasons, including those described above, a user of the wireless phone 12 may wish to keep the primary phone number private, and obtain one or more other phone numbers (e.g., “secondary” phone numbers) that he or she can release to others. To this end, the user may initiate a request for a secondary telephone number in a manner described further below. In response to the request, the telecommunications server 16 assigns a secondary telephone number (from a list of available secondary phone numbers) to the wireless phone 12, and thereafter forwards phone calls directed to the secondary telephone number of the wireless phone 12 to the primary phone number of the wireless phone 12, optionally modifying the Caller ID information to include an indication of the secondary number.

FIG. 2 is a front view of the wireless phone 12 of FIG. 1. In the embodiment of FIG. 2, the wireless phone 12 includes a user interface with a touch-sensitive display screen 40, one or more physical buttons 42, a microphone 44 positioned on an edge portion, and a speaker 46 positioned in a top portion. In FIG. 2, a graphical button 48 is displayed on the touch-sensitive display screen 40. In general, a graphical button is a defined portion of the touch-sensitive display screen that has one or more actions associated with it. The user of the wireless phone 12 activates the button 48 by touching the display screen within the defined portion. Activation of the button 48 causes the one or more actions associated with the button 48 to be carried out. In FIG. 2, text of the button 48 reads “GET iNONYMOUS NUMBER.” As described in more detail below, when a user of the wireless phone 12 activates the button 48, a processor of the wireless phone 12 executes software instructions to obtain a phone number from the telecommunications server 16 (FIG. 1) via the communication network 14 (FIG. 1).

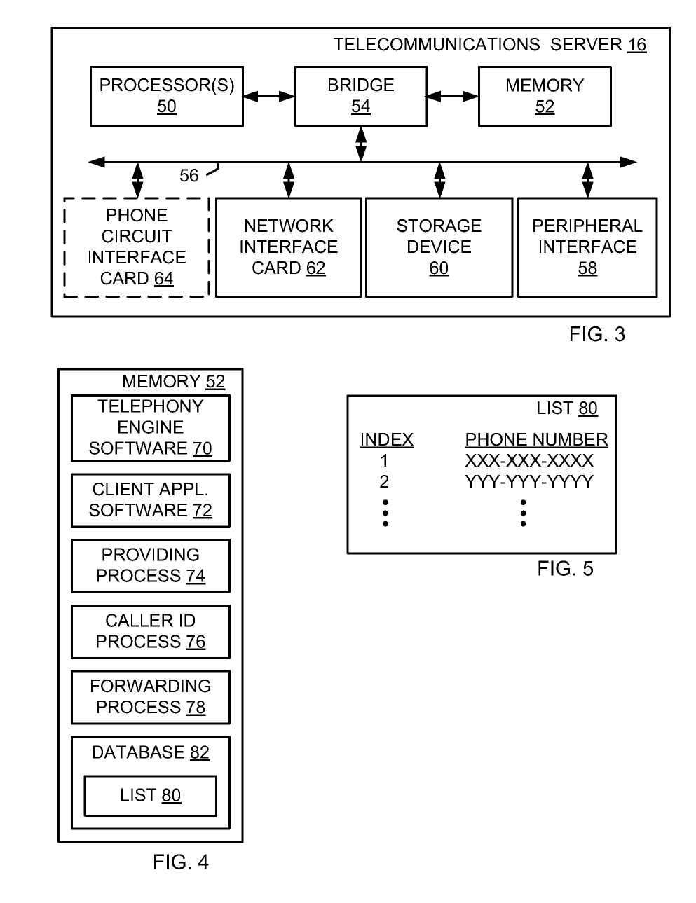

FIG. 3 is an illustrative block diagram of one embodiment of the telecommunications server 16 of FIG. 1. In the embodiment of FIG. 3, the telecommunications server 16 includes one or more processor(s) 50 coupled to a memory 52 via a bridge 54. The bridge 54 is also coupled to a bus 56. The bus 56 enables the processor(s) 50 to communicate with a peripheral interface 58, a storage device 60, a network interface card 62, and an optional phone circuit interface card 64.

The peripheral interface 58 provides ports for communicating with external devices such as keyboard, mice, universal serial bus (USB) devices, printers, cameras, speakers, etc. On many servers, these ports may be left largely unused, but they are available for configuration, diagnostic, and performance monitoring purposes. The storage device 60 is typically a nonvolatile memory for firmware and/or a hard drive for extended storage of software and data. On distributed systems with high data availability requirements, the storage device 60 is replaced or supplemented with a storage area network (SAN) card that enables shared access to a large disk array. The network interface card 62 provides access to the Internet 20 (see FIG. 1) and to other network servers. The optional phone circuit interface card 64 may provide access to the PSTN 18 (see FIG. 1). Alternatively, the telecommunications server 16 may connect to the PSTN 18 indirectly via Voice over Internet Protocol (VoIP) techniques, eliminating the need for dedicated telephone circuit interface hardware.

FIG. 4 is a diagram of one embodiment of the memory 52 of the telecommunications server 16 of FIG. 3. In the embodiment of FIG. 4, the memory 52 includes telephony engine software 70, client application software 72, a providing process 74, a Caller ID process 76, a forwarding process 78, and a database 82, which optionally includes one or more lists 80 of secondary phone numbers, each list being associated with a primary phone number. In some embodiments, the database 82 further includes for each secondary phone number a call history, e.g., a list of calls to that secondary phone number, including caller-id information, call times, and call durations. Such embodiments enable two-way anonymity, i.e., both the caller and the holder of the secondary phone number can keep their primary numbers private.

The telephony engine software 70 includes software instructions for receiving and initiating phone calls. The telephony engine software 70 may be or include, for example, the Asterisk® telephony engine software (Digium®, Inc., Huntsville, Ala.). The setup and operation of the Asterisk® telephony engine software is described in Asterisk: The Future of Telephony by J. Van Meggelen, J. Smith, and L. Madsen, ©2005 O'Reilly Media, Inc, which is hereby incorporated herein by reference. During operation, the processor(s) 50 (see FIG. 3) of the telecommunications server 16 fetch software instructions of the telephony engine software 70 from the memory 52, and execute the instructions to carry out the operations described below.

The client application software 72, described in more detail below, includes downloadable software instructions for execution by the wireless phone 12. In response to a request from the wireless phone 12, the telecommunications server 16 transfers a copy of the client application software 72 to the wireless phone 12. The client application software 72 enables the user of the wireless phone 12 to obtain one or more temporary phone numbers from the telecommunications server 16, to manage the one or more secondary phone numbers, and to selectively dispose of the secondary phone numbers.

The providing process 74 includes software instructions for receiving a request for a secondary phone number and responsively providing a secondary phone number to the wireless phone 12. In some embodiments, the software instructions of the providing process 74 cause the telecommunications server 16 to first collect information about the wireless phone 12 and/or the user of the wireless phone 12, then access a list of available secondary phone numbers, select a secondary phone number from the list, assign the secondary phone number to the wireless phone 12, and send the selected secondary phone number to the wireless phone 12. For example, the providing process may send the wireless phone 12 an electronic message containing the secondary phone number.

The Caller ID process 76 includes software instructions for modifying the Caller ID information of a phone call directed to a secondary phone number associated with the wireless phone 12. As described in more detail below, the software instructions of the Caller ID process 76 modify the Caller ID information such that when the server forwards the phone call to the primary number, the Caller ID information indicates the secondary phone number to which the call was directed (i.e., the dialed number). The Caller ID process 76 also computes a new checksum for the modified Caller ID information.

The forwarding process 78 includes software instructions for receiving an incoming phone call to a secondary number, determining the primary number associated with that secondary number, and forwarding the incoming phone call to the primary phone number of the wireless phone 12 with the modified Caller ID information, where the modified Caller ID information includes an indication of the dialed number.

The secondary phone number list 80, described in more detail below, includes a list of all secondary phone numbers associated with a given primary phone number. In the list 80, the secondary phone numbers may be, for example, associated with a primary phone number of the wireless phone 12. Each of the secondary phone numbers associated with the wireless phone 12 has a corresponding index. In some embodiments, the Caller ID process 76 includes software instructions for inserting a value into the Caller ID information that indicates the index of the dialed number in the list 80. The value may be, for example, an ASCII value of an alphabetic character.

The database 82 includes information about received and forwarded phone calls. The information stored in the database 82 may include, for example, the names of calling parties, and/or the phone numbers of calling parties. The information may also include, for example, the dates the phone calls were made, the start times of the phone calls, the end times of the phone calls, and/or the durations of the phone calls. The telecommunications server 16 may send some or all of the information associated with a secondary phone number to the wireless phone 12 to help the user of the wireless phone 12 manage the one or more secondary phone numbers, and/or make decisions regarding the disposal of the secondary phone numbers.

FIG. 5 is a diagram of one embodiment of the list 80 of FIG. 4. In the embodiment of FIG. 5, the list 80 includes two secondary phone numbers associated with the wireless phone 12: a first secondary phone number “XXX-XXX-XXXX” (where each “X” is a digit between 0 and 9) and a second secondary phone number “YYY-YYY-YYYY” (where each “Y” is a digit between 0 and 9). The first secondary phone number XXX-XXX-XXXX has an index “1,” and the second secondary phone number YYY-YYY-YYYY has an index “2.” Some alternative embodiments also maintain a call history, which can take the form of a list of caller-id information for incoming calls to a given secondary phone number.

The telecommunications server 16 of FIGS. 1 and 3 may optionally record all conversations directed to a secondary number and forwarded by the telecommunications server 16. A recorded conversation may be, for example, stored in a voice mailbox, and/or recorded as an audio file. The audio file may be, for example, subsequently attached to an email message sent to the wireless phone user. This conversation recording capability may be offered to wireless phone users as an additional cost option.

The telecommunications server 16 of FIGS. 1 and 3 may also include one or more features that allow the user of the wireless phone 12 (see FIG. 1) to make calls that appear to be made from a secondary phone number assigned to the wireless phone 12. Such features would allow the user to keep the primary phone number of the wireless phone 12 private. For example, in some embodiments, if the user calls a secondary phone number assigned to the wireless phone 12, the telecommunications server 16 recognizes the phone call as originating from the wireless phone 12, and allows the user to make outgoing calls. Recognizing that the phone call originates from the wireless phone 12 may be accomplished by, for example, determining the primary phone number associated with a dialed secondary number and comparing that primary phone number to the originating phone number in the caller id information. If the primary phone number matches the originating phone number, the telecommunications server 16 routes the phone call to an administrative routine that allows the user to enter a 10 digit phone number the user would like to call. The telecommunications server 16 then initiates an outdoing phone call to the entered phone number, and connects the incoming phone call to the outgoing phone call. When the outgoing phone call is initiated, the caller id information of the outgoing phone call indicates that the originating phone number is the secondary phone number. The resulting phone call appears to be made from the secondary phone number, and any return calls to the secondary phone number are routed by the telecommunications server 16 to the user of the wireless phone 12.

The telecommunications server 16 of FIGS. 1 and 3 may also provide a convenient call back feature where caller id information indicates that the originating phone number is the primary phone number associated with the dialed secondary phone number. In some embodiments, when a call to a secondary phone number assigned to the wireless phone 12 (see FIG. 1) goes unanswered, the telecommunications server 16 logs a call back request including a two-digit call back request number. The caller's phone number and the associated call back request number are stored in a database (e.g., the database 82 of FIG. 4). The telecommunications server 16 may also record a voice message from the caller as part of the call back request. When the user of the wireless phone 12 calls the secondary phone number, the telecommunications server 16 may provide a voice message to the user such as: “You have 10 call back requests. To call the most recent one, press star, or enter the two-digit number of the call back you wish to call.” When the user enters a two-digit call back request number, the telecommunications server 16 accesses the database, retrieves the phone number associated with the entered call back request number, initiates an outgoing phone call to the phone number, and connects the incoming phone call from the wireless phone 12 to the outgoing phone call. When the outgoing phone call is initiated, the caller id information of the outgoing phone call indicates that the originating phone number is the secondary phone number. Alternatively, or in addition, the telecommunications server 16 may first play back a recorded voice message left by the caller as part of the call back request.

It should be noted that the application software can make such anonymized calling more convenient. When a user invokes the application software on a wireless phone to place a new call or “call-back” a previous caller, the application software can initiate the call by first dialing the secondary number and, when the telecommunications server answers, dialing an “extension” number. The extension number for a call-back can be the two-digit index value that the application software has extracted from a modified caller-id number, or it can be other anonymized caller identifying information that the server can use to determine a phone number, e.g., a call time. For a new call, the extension number can be a ten-digit number that the user has entered into the application software.

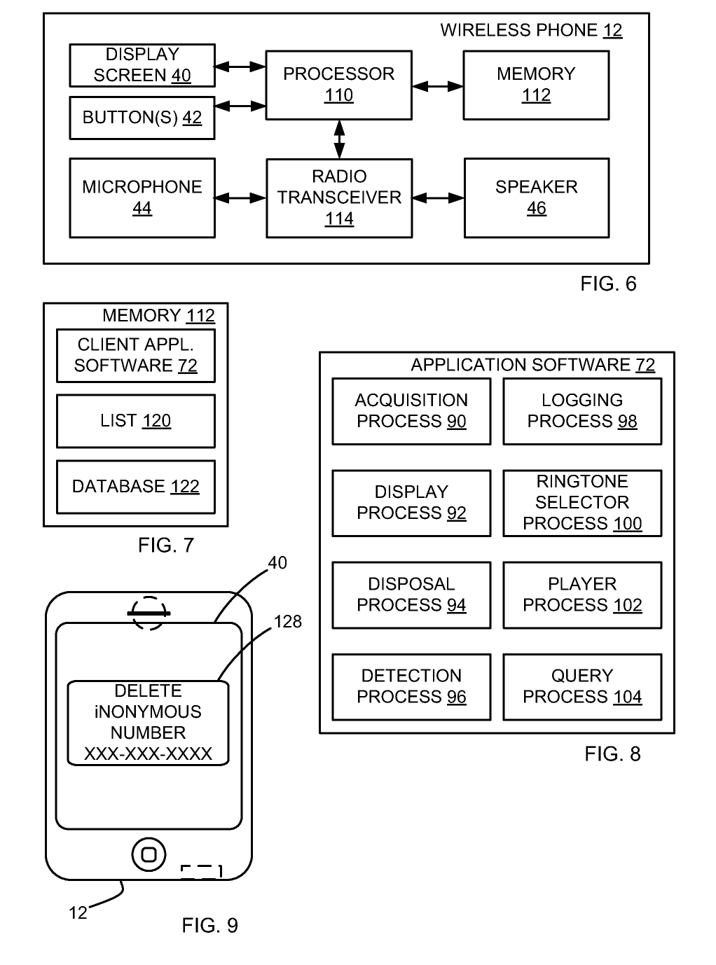

FIG. 6 is an illustrative block diagram for one embodiment of the wireless phone 12 of FIGS. 1 and 2. In the embodiment of FIG. 6, the wireless phone 12 includes a processor 110 coupled to the display screen 40 (see FIG. 2), the one or more physical buttons 42 (see FIG. 2), a memory 112, and a radio transceiver 114. The radio transceiver 114 is coupled to the microphone 44 and the speaker 46 (see FIG. 2). During operation, the processor 110 fetches software instructions from the memory 112, and executes the instructions to control the display screen 40 and the radio transceiver 114, enabling the user to, among other things, make and receive phone calls, and download and run software.

Users of wireless phones are often able to obtain or purchase downloadable software from the internet. For example, Apple® offers a store where users can shop for iPhone® applications to download to their iPhone® devices. Such software includes games and utilities. The client application software 72 is one example of a software utility that can be made available in this manner, or made available for download from any given server on the internet, including telecommunications server 16. In some alternative embodiments, the wireless phone is sold with such software pre-installed for the customer's use. FIG. 7 is an illustrative embodiment of the memory 112 of FIG. 6 following download and execution of a copy of the client application software 72. In the embodiment of FIG. 6, the memory 112 includes the copy of the client application software 72, a secondary phone number list 120, and a database 122.

The list 120 includes a list of all secondary phone numbers associated with the wireless phone 12. In the list 120, the secondary phone numbers may be, for example, associated with a primary phone number of the wireless phone 12. Each of the secondary phone numbers associated with the wireless phone 12 has a corresponding index.

In some embodiments, the list 120 is identical to the corresponding list 80 constructed and maintained by the telecommunications server 16 for that wireless phone (see FIG. 4). In this situation, the corresponding indexes of the secondary phone numbers are identical. The wireless phone 12 may build and maintain the list 120 on its own, or with information provided by the telecommunications server 16. Alternatively, the telecommunications server 16 may build and maintain the list 80 (see FIG. 4), and make a copy of the list 80 available for the application software to retrieve. When received and stored in the memory 112, the copy of the list 80 may become the list 120. In some embodiments, the telecommunication server tracks call history information for each of the secondary phone numbers. The application software can retrieve such call history information when desired, e.g., when providing the user an option to renew or dispose of a secondary number. The call history can be anonymized, e.g. omitting caller-id numbers in favor of indexes to a private list kept on the server.

In other embodiments, the wireless phone tracks call history information for secondary phone numbers in a database 122. The information stored in the database 122 may include, for example, the names of calling parties, and/or the phone numbers of calling parties. The information may also include, for example, the dates the phone calls were made, the start times of the phone calls, the end times of the phone calls, and/or the durations of the phone calls.

The user of the wireless phone 12 may use information in the database 122 to manage one or more secondary phone numbers associated with the wireless phone 12, and/or make decisions regarding the disposal of one or more secondary phone numbers associated with the wireless phone 12. The client software 72 may construct and maintain the database 122 on its own, or with information provided by the telecommunications server 16. In some embodiments, the telecommunications server 16 may construct and maintain the database 82 (see FIG. 4), and send a copy of the database 82 to the wireless phone 12. When received and stored in the memory 112, the copy of the database 82 may become the database 122.

FIG. 8 is a software component diagram for one embodiment of the client application software 72 of FIGS. 4 and 7. As described above, the client application software 72 includes software instructions for execution by the wireless phone 12, and the client application software can be obtained from various sources by request, including the telecommunications server 16. In the embodiment of FIG. 8, the client application software 72 includes an acquisition process 90, a display process 92, a disposal process 94, a detection process 96, a logging process 98, a ringtone selector process 100, a player process 102, and a query process 104.

The acquisition process 90 includes software instructions for obtaining a new secondary phone number from the telecommunications server 16. The acquisition process 90 preferably works with the providing process 74 of the telecommunications server 16 (see FIG. 4). Executed on the wireless phone 12, the software instructions of the acquisition process 90 may, for example, gather information about the wireless phone 12 and/or the user of the wireless phone 12, and send the information to the telecommunications server 16. In some embodiments, the information gathered by the software instructions of the acquisition process 90 includes a phone number assigned to the wireless phone 12 (e.g., by a phone system provider). After providing information about the wireless phone 12 and/or the user of the wireless phone 12 to the telecommunications server 16, the software instructions of the acquisition process 90 may receive a secondary phone number from the telecommunications server 16.

The display process 92 includes software instructions for displaying the secondary phone number to the user of the wireless phone 12. For example, the software instructions may cause the secondary number to be displayed on the display screen of the display screen 40 of the wireless phone 12 (see FIG. 2). As described above, the telecommunications server 16 may send the wireless phone 12 an electronic message containing the secondary phone number. The acquisition process 90 may receive the electronic message, and provide the secondary phone number to the display process 92.

The disposal process 94 includes software instructions for disassociating a secondary phone number associated with the wireless phone 12. The disassociating may be carried out automatically by the software instructions of the disposal process 94 at the end of a set period of time, or by the user of the wireless device 12.

The detection process 96, described in more detail below, includes software instructions for determining the dialed number of incoming calls. The logging process 98 includes software instructions for tracking incoming Caller ID information for each secondary phone number associated with the wireless phone 12.

The ringtone selector process 100 includes software instructions for playing a selected ringtone to announce an incoming call. For example, a different ringtone may be assigned to each secondary phone number associated with the wireless phone 12. When a call to one of the secondary phone numbers is received by the wireless phone 12, the software instructions of the ringtone process 100 may select the ringtone to be played dependent upon the dialed number of the incoming call. The player process 102 includes software instructions for playing a ringtone selected by the ringtone selector process 100 via the speaker 46 of the wireless phone 12 (see FIG. 2).

The query process 104 includes software instructions for, upon completion of an incoming phone call, querying the user of the wireless phone 12 as to whether the secondary phone number to which the phone call was placed (i.e., the dialed number) should be disassociated from the wireless phone 12. If the user of the wireless phone 12 response in the affirmative, the query process 104 may invoke the disposal process 94 to disassociate the secondary phone number dialed from the wireless phone 12. The query process 104 may display a list of callers to a secondary phone number when providing the user the option to disassociate the secondary phone number from the wireless phone 12.

Referring to FIGS. 4, 5 and 7, the list 80 of the telecommunications server 16 (see FIGS. 4 and 5) and the list 120 of the wireless phone 12 (see FIG. 7) may be identical. The Caller ID process 76 of the telecommunications server 16 (see FIG. 4) includes software instructions for inserting a value into the Caller ID information provided to the wireless phone 12 that indicates the index of the dialed number in the list 80. The value may be, for example, an ASCII value of an alphabetic character. The index of the dialed number in the list 80 is the same as the index of the dialed number in the list 120. Using the received Caller ID information that indicates the index of the dialed number, the detection process 96 of the client application software 72 (see FIG. 8) can determine the secondary phone number to which the phone call was placed (i.e., the dialed number).

For example, in both the lists 80 and 120, the first secondary phone number XXX-XXX-XXXX associated with the wireless phone 12 may have the corresponding index “1” (see FIG. 5). When the telecommunications server 16 receives an incoming phone call directed to the first secondary phone number XXX-XXX-XXXX, the Caller ID process 76 (see FIG. 4) may insert the ASCII value of the alphabetic character “a” in the Caller ID information sent to the wireless phone 12 when the phone call is forwarded to the wireless phone 12. Using the received Caller ID information “a” that indicates the index of the dialed number, the detection process 96 of the client application software 72 (see FIG. 8) can determine that the secondary phone number to which the phone call was placed (i.e., the dialed number) is the first secondary number XXX-XXX-XXXX.

FIG. 9 is a front view of the wireless phone 12 of FIGS. 1, 2, and 6, where a button 128 is displayed on the touch-sensitive display screen of the display screen 40. Text of the button 128 reads “DELETE iNONYMOUS NUMBER XXX-XXX-XXXX.” The button 128 may be displayed, for example, by the query process 104 (see FIG. 5) after the completion of a telephone call directed to the secondary phone number XXX-XXX-XXXX. When the user of the wireless phone 12 activates the button 128, the disposal process 94 of the client application software 72 (see FIG. 5) is invoked, and the secondary phone number XXX-XXX-XXXX is disassociated from the wireless phone 12.

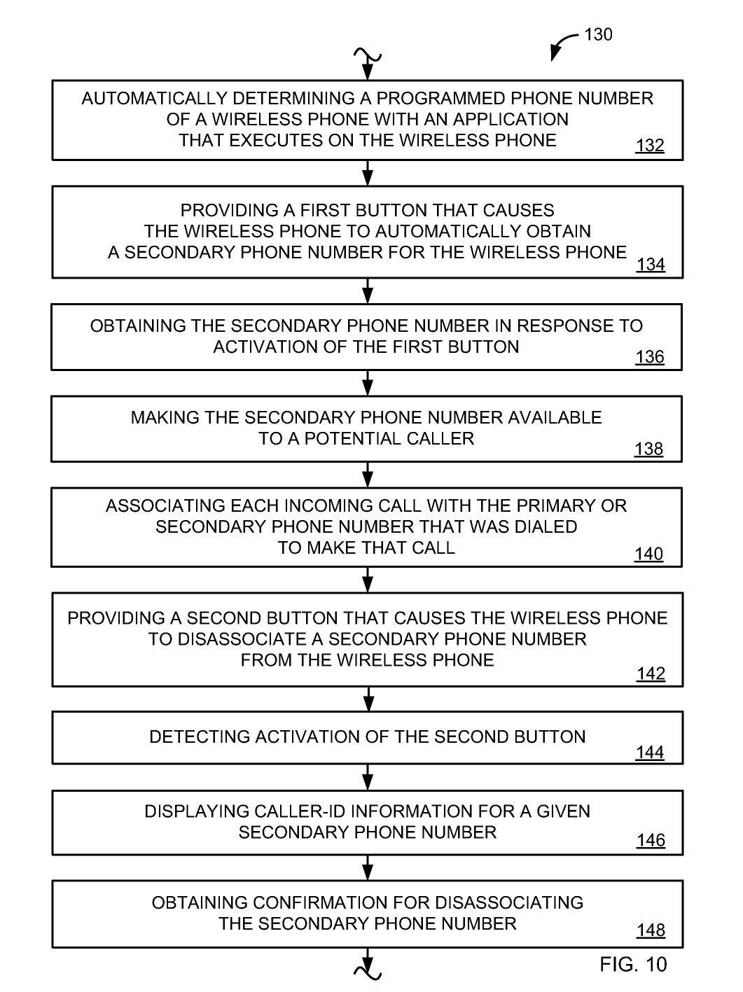

FIG. 10 is a flowchart of one embodiment of a method 130 for enabling anonymous reception of phone calls. A step 132 of the method 130 includes automatically determining a programmed phone number of a wireless phone (e.g., the wireless phone 12 of FIGS. 1, 2, 6, and 9) with an application (e.g., the client application software 72 of FIGS. 4 and 6) that executes on the wireless phone. During a step 134, a first button (e.g., the button 48 of FIG. 2) is provided that causes the wireless phone to automatically obtain a secondary phone number for the wireless phone. A step 136 includes obtaining the secondary phone number in response to activation of the first button, and the secondary phone number is made available to a potential caller (e.g., the user of the wireless phone 12 of FIGS. 1, 2, 6, and 9) during a step 138.

The step 138 may include, for example, displaying the secondary phone number on a display screen of the wireless phone. Alternatively, or in addition, the step 138 may include communicating the secondary phone number in an electronic message directed to the potential caller.

During a step 140, the wireless phone associates each incoming call with the primary or secondary phone number that was dialed to make that call. A second button (e.g., the button 128 of FIG. 9) is provided that causes the wireless phone to disassociate a secondary phone number from the wireless phone during a step 142.

A step 144 involves detecting activation of the second button. Caller ID information for a given secondary phone number is displayed during a step 146, and a step 148 involves obtaining confirmation for disassociating the secondary phone number.

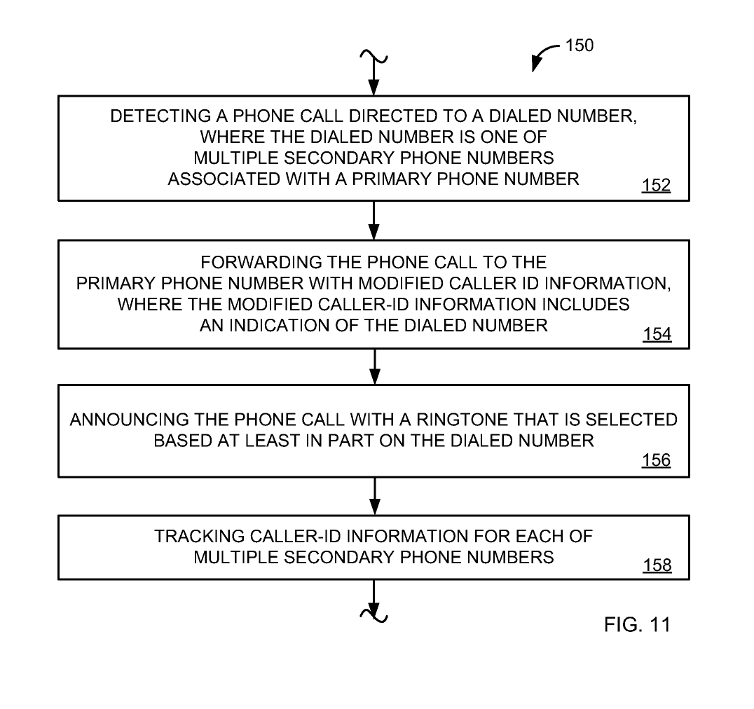

FIG. 11 is a flowchart of one embodiment of a method 150 for placing a telephone call. The method 150 may be used to carry out the step 140 of the method 130 of FIG. 10. A step 152 of the method 150 includes detecting a phone call directed to a dialed number, where the dialed number is one of multiple secondary phone numbers associated with a primary phone number. During a step 154, the phone call is forwarded to the primary phone number with modified Caller ID information, wherein the modified Caller ID information includes an indication of the dialed number. A step 156 includes announcing the phone call with a ringtone that is selected based at least in part on the dialed number. During a step 158, Caller ID information for each of multiple secondary phone numbers is tracked.

Numerous variations and modifications will become apparent to those skilled in the art once the above disclosure is fully appreciated. It is intended that the following claims be interpreted to embrace all such variations and modifications.

What is claimed is:

1. A wireless phone that comprises:
a user interface having at least one button;
a processor coupled to the user interface to detect a user's activation of the button; and
internal software stored in memory, the software comprising:
an acquisition process that configures the processor to obtain a secondary phone number for the wireless phone in response the user's activation of the button; and
a display process that configures the processor to display the secondary phone number to the user.

2. The phone of claim 1, wherein the software further comprises a disposal process that configures the processor to disassociate a secondary phone numbers associated with the wireless phone based at least in part on the expiration of a given time period.

3. The phone of claim 1, wherein the software further comprises a disposal process that configures the processor to disassociate a secondary phone number associated with the wireless phone if the user activates a disposal button.

4. The phone of claim 1, wherein the software further comprises a detection process that configures the processor to determine the dialed number of incoming calls.

5. The phone of claim 4, wherein the processor determines the dialed number based at least in part on a dialed number indicator in a caller-id field.

6. The phone of claim 4, wherein the software further comprises a ringtone process that plays a selected ringtone to announce an incoming call, wherein selection of the ringtone is based at least in part on the dialed number of the incoming call.

7. The phone of claim 4, wherein the software further comprises a query process that configures the processor to query a user upon completion of an incoming phone call whether said dialed number should be disassociated from the wireless phone.

8. The phone of claim 1, wherein the software further comprises a query process that configures the processor to display a list of callers to a secondary phone number when providing a user an option to have said secondary phone number expire or be disassociated from the wireless phone.

9. A method of enabling anonymous reception of phone calls, the method comprising:
automatically determining a programmed phone number of a wireless phone with an application that executes on said wireless phone; and
providing a button that causes the wireless phone to automatically obtain a secondary phone number for the wireless phone.

10. The method of claim 9, further comprising:
obtaining the secondary phone number in response to activation of the button; and
making the secondary phone number available to a potential caller.

11. The method of claim 10, wherein said making includes displaying the secondary phone number on the wireless phone.

12. The method of claim 10, wherein said making includes communicating the secondary phone number in an electronic message directed to the potential caller.

13. The method of claim 10, further comprising:
at the wireless phone, associating each incoming call with the primary or secondary phone number that was dialed to make that call.

14. The method of claim 9, further comprising:
providing a button that causes the wireless phone to disassociate a secondary phone number from the wireless phone.

15. A telecommunications server that comprises:
at least one processor that receives an incoming phone call to one of multiple numbers currently associated with a receiving phone; and
memory having software that comprises:
a caller-id process that causes the processor to modify a caller-id associated with the incoming phone call to characterize a dialed number of the incoming phone call; and
a forwarding process that causes the processor to forward the incoming phone call to the receiving phone with the modified caller-id.

16. The server of claim 15, wherein the server maintains a list of phone numbers associated with the receiving phone, and wherein the processor inserts a value into the caller-id to indicate the index of the dialed number in the list.

17. The server of claim 16, wherein the value is an ASCII value of an alphabetic character that is appended to the phone number in the caller-id.

18. The server of claim 15, wherein the processor forms a checksum of the dialed number and inserts the checksum into the caller-id.

19. A calling method that comprises:
detecting a phone call directed to a dialed number, wherein the dialed number is one of multiple secondary phone numbers associated with a primary phone number; and
forwarding the phone call to the primary phone number with modified caller-id information, wherein the modified caller-id information includes an indication of the dialed number.

20. The method of claim 19, further comprising:
announcing the phone call with a ringtone that is selected based at least in part on the dialed number.

21. The method of claim 19, further comprising:
tracking caller-id information for each of multiple secondary phone numbers; and
displaying caller-id information for a given secondary phone number.

22. A wireless phone that comprises:
a speaker;
a processor that detects an incoming phone call having a caller identification field value that includes a dialed-number indicator; and
a memory having software that comprises:
a ringtone selector process that configures the processor to select a ringtone based at least in part on the dialed-number indicator; and
a player process that configures the processor to play the selected ringtone via the speaker to announce the incoming phone call.

23. The phone of claim 22, wherein the phone has a primary phone number and at least one secondary phone number.

24. The phone of claim 23, wherein the software further comprises an acquisition process that configures the processor to obtain a new secondary number.

25. The phone of claim 22, wherein the software further comprises a query process that configures the processor to query a user upon completion of an incoming phone call whether said dialed number should be disassociated from the wireless phone.

26. A wireless phone that comprises:
a user interface having at least one button;
a processor coupled to the user interface to detect a user's activation of the button; and
a memory having software that comprises:
a logging process that tracks incoming caller identification information for each of multiple phone numbers dialed to reach said wireless phone; and
a query process that displays the tracked caller identification for a phone number when a user activates the button to disassociate that phone number from the wireless phone.

27. The phone of claim 26, wherein the caller identification information includes a dialed number indicator.

28. The phone of claim 27, wherein the dialed number indicator is an index in a list of phone numbers associated with the wireless phone.

29. The phone of claim 28, wherein the value is an ASCII value of an alphabetic character that is appended to the phone number in the caller-id.

30. The phone of claim 27, wherein the processor forms a checksum of the dialed number and inserts the checksum into the caller-id.
